(19) United States
(12) Patent Application Publication
(10) Pub. No.: US 2011/0272107 A1
(43) Pub. Date: Nov. 10, 2011

(54) SAFETY CORD RELEASER FOR WINDOW COVERING

(75) Inventors: Yu-Che Wen, Taoyuan County (TW); Chao-hung Nien, Taichung City (TW)

(73) Assignee: NIEN MADE ENTERPRISE CO., LTD., Taichung City (TW)

(21) Appl. No.: 12/773,254

(22) Filed: May 4, 2010

(51) Int. Cl. A47H 5/02; E06B 9/24; F16G 11/10

(52) U.S. Cl. 160/340; 24/115 F

(57) ABSTRACT

The present invention provides a window covering with a safety cord releaser. The cord releaser includes a hanging member connected to an end of a cord of the window covering and a blocking member connected to a valance of the window covering. The hanging member has an engaging portion, which has an engaging space, a gateway to be an entrance of the engaging space, and two edges at opposite sides of the gateway. The blocking member has a blocking portion to be detachably engaged with the engaging space of the hanging portion. The block portion has an oval cross section and the engaging space of the hanging member is complementary to it that only at a specific angle the blocking member is able to be engaged and disengaged with the hanging member.

### BACKGROUND OF THE INVENTION

1. Field of the Invention

The present invention relates generally to a window covering product, and more particularly to a window covering with a safety releaser, and a safety cord releaser used in such window covering.

2. Description of the Related Art

A conventional window covering has a pull cord to fold and unfold a window covering blanket thereof. Such window covering usually has a suspended cord for operation. It occasionally causes accidents when children play with the cord and the cord winds around his/her neck. Manufacturers are working on providing safety window coverings to avoid such accident. For example, a detachable safety device is provided between the cord and the top rail of the window covering product.

As shown in FIG. 1, a conventional safety device includes a magnet 2 connected to an end of a cord 1 and a magnet 4 fixed to a top rail 3. The magnet 2 and 4 will be separated from the window covering when the cord 1 is pulled by a great strength.

FIG. 2 shows another safety device including a connector 5 and a locker 6. The connector 5 is fixed to a valance 7, and has a bore 5a and a stop portion 5b on a sidewall of the bore 5a. The locker 6 is fastened at an end of a cord 8, and has two separated elastic members 6a, each of which has a protrusion 6b. The connector 5 is engaged with the locker 6 that the cord 8 can be pulled to fold or unfold the valance 7. The locker 6 is disengaged with the connector 5 by the elastic members 6a being deformed and the protrusions 6b passing over the stop portion 5b when the cord 8 is pulled by a great strength that the cord 8 is separated from the window covering.

These safety devices serve the function of releasing the cord when the cord is pulled by a great strength to protect children from being strangulated by the cord. However, they still have some drawbacks.

For example, it is difficult to set the strength value for disengagement of the magnets 2, 4 and the connector 5 and the locker 6. For the second safety device, the factors affecting the strength value for disengagement of the connector 5 and the locker 6 include heights of the stop portions 5b, flexibility of the elastic members 6a, shapes of the protrusions 6b, etc., so the quality of the conventional safety devices is hard to control. In other words, even with a high value for disengagement the cord still has a risk of strangulating kids, and on the contrary, with a low value for disengagement the cord will be too easy to become loose.

Another problem of the second safety device is material fatigue. The elastic members will fail because of long time exposure under sunshine and repeated operation. This will decrease the strength of disengaging the safety device. In conclusion, both the first and second safety devices are not good designs.

### SUMMARY OF THE INVENTION

The primary objective of the present invention is to provide a safety cord releaser for a window covering, which will not become loose by a small strength but still may prevent the cord from strangulating kids.

To achieve the objective of the present invention, a cord releaser includes a hanging member and a blocking member. The hanging member has an engaging portion, which has an engaging space, a gateway to be an entrance of the engaging space, and two edges at opposite sides of the gateway. A distance between the edges is a maximum width of the gateway. The blocking member has a blocking portion to be detachably engaged with the engaging space of the hanging portion which has a long axis and a short axis at a cross section thereof. The long axis is greater than the maximum width of the gateway of the hanging member, and the short axis is shorter than the maximum width of the gateway that in a condition of the short axis of the blocking portion of the blocking member being substantially parallel to the maximum width of the gateway, the blocking member is able to be engaged and disengaged with the hanging member.

In an embodiment, the present invention provides a window covering incorporated with the cord releaser. The hanging member is connected to a cord of the window covering, and the blocking member is connected to a valance of the window covering. The hanging member is engaged and disengaged with the blocking member when short axis of the blocking portion of the blocking member is substantially parallel to the maximum width of the gateway the blocking member.

In an embodiment, the cross section of the blocking portion of the blocking member is oval and the long axis and the short axis are orthogonal, and the engaging space of the hanging member, which is complementary to the blocking portion of the blocking member, having a long axis and a short axis that the blocking member is unable to be disengaged with the hanging member when the blocking portion is engaged with the engaging space and the long axis of the blocking portion is substantially parallel to the maximum width of the gateway.

In order to ensure a correct installation of the hanging member and the blocking member, the blocking portion of the blocking member is provided with a protrusion to be in touch with the edge when the hanging member tries to be engaged with the blocking member in an incorrect position.

In another embodiment, the blocking member can be a bar, rod or rail within the window covering product itself, and the bar, rod or rail's profile can have a long axis and a short axis to be engaged and disengaged with the hanging member.

In addition, to avoid an unexpected disengagement of the hanging member and the blocking member, the present invention further provides a cover pivoted on the hanging member to be moved between a covered position, in which a body of the cover blocks the gateway of the hanging member, and an uncovered position, in which the body of the cover exposes the gateway of the hanging member.

### BRIEF DESCRIPTION OF THE DRAWINGS

FIG. 1 is a perspective view of the first conventional safety device for the window covering;

FIG. 2 is a sketch diagram of the second conventional safety device for the window covering;

FIG. 3 is a perspective view of the window covering incorporated with the cord releaser of a preferred embodiment of the present invention;

FIG. 4 is a front view of the hanging member of the cord releaser of the preferred embodiment of the present invention in the folded condition;

FIG. 5 is a sketch diagram of the engaging space of the hanging member of the preferred embodiment of the present invention in the folded condition;

FIG. 6 is a perspective view of the blocking member of the cord releaser of the preferred embodiment of the present invention in the folded condition;

FIG. 7 is a sketch diagram of the cross section of the blocking member of the preferred embodiment of the present invention;

FIG. 8 is a front view of the preferred embodiment of the present invention, showing the engagement of the hanging member and the blocking member;

FIG. 9 is an enlarged view of FIG. 8;

FIG. 10 is a sketch diagram, showing a kid strangulated by the cord;

FIG. 11 is an enlarged view of FIG. 10;

FIG. 12 is a perspective view of the coupler of the preferred embodiment of the present invention;

FIG. 13 is a sketch diagram, showing the correct engagement of the hanging member and the blocking member;

FIG. 14 is a sketch diagram, showing the incorrect engagement of the hanging member and the blocking member;

FIG. 15 is a perspective view of the cover of the preferred embodiment of the present invention;

FIG. 16 is a sketch diagram, showing the cover at the uncovered position;

FIG. 17 is a sketch diagram, showing the cover at the covered position;

FIG. 18 is similar to FIG. 3, showing the engagement of the hanging member and the bar; and

FIG. 19 is an enlarged view of FIG. 18.

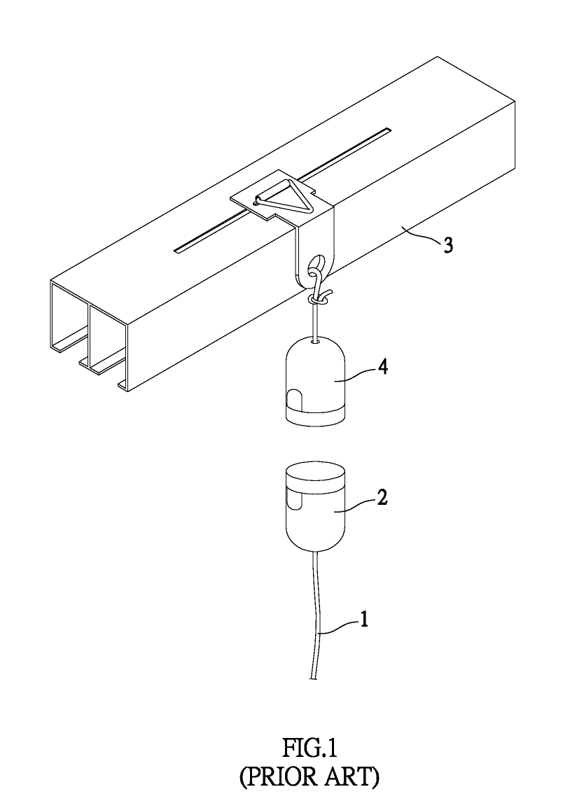

### DETAILED DESCRIPTION OF THE INVENTION

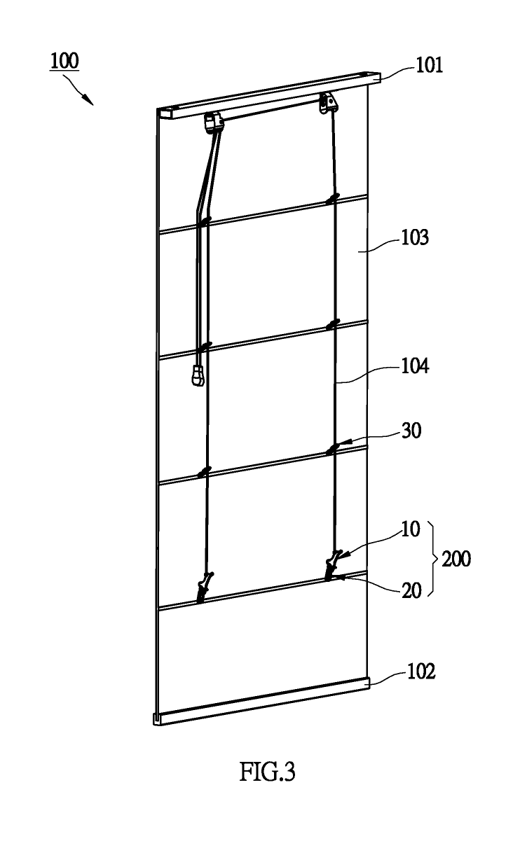

The present invention provides a safety cord releaser 200 for a window covering 100. As shown in FIG. 3, the window covering 100 includes a top rail 101, a bottom rail 102, a valance 103 with opposite ends connected the top rail 101 and the bottom rail 102, and a cord 104 for manipulation to fold and unfold the valance 103. The safety cord releaser 200 includes a hanging member 10 and a blocking member 20.

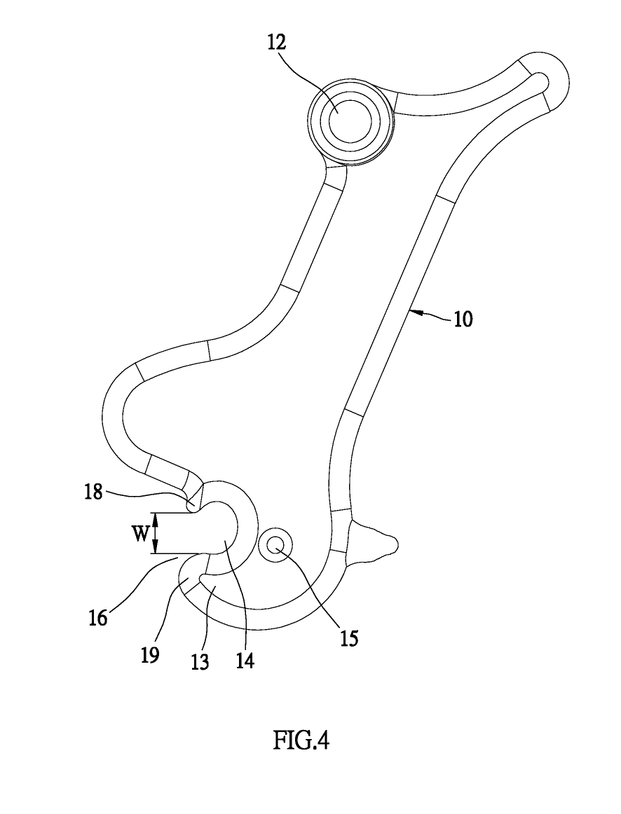

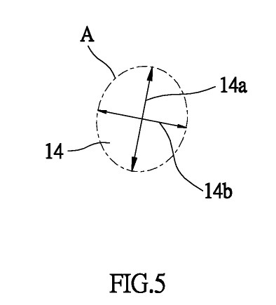

As shown in FIG. 4, the hanging member 10 has a pivoting portion, which is an opening 12, for the cord 104 to pass through and tie a knot to fasten the cord 104 to the hanging member 10. The hanging member 10 further has an engaging portion, opposite to the pivoting portion, having an engaging space 14, a gateway 16, and two edges. Please referring to FIG. 5, the engaging space 14 is oval having a long axis 14a and a short axis 14b orthogonal to the long axis 14a. “A” indicates an oval, within which is the engaging space 14, with the gateway 16 thereon and a first edge 18 and a second edge 19 at opposite sides of the gateway 16. A distance W between the first edge 18 and the second edge 19 is a maximum width of the gateway 16. The hanging member 10 further has a hooking portion 13 beside the second edge 19.

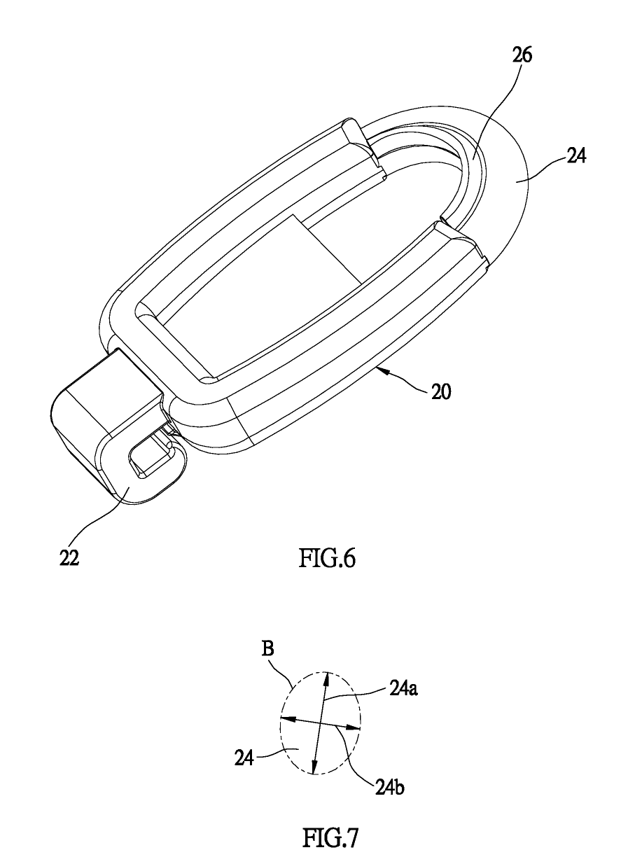

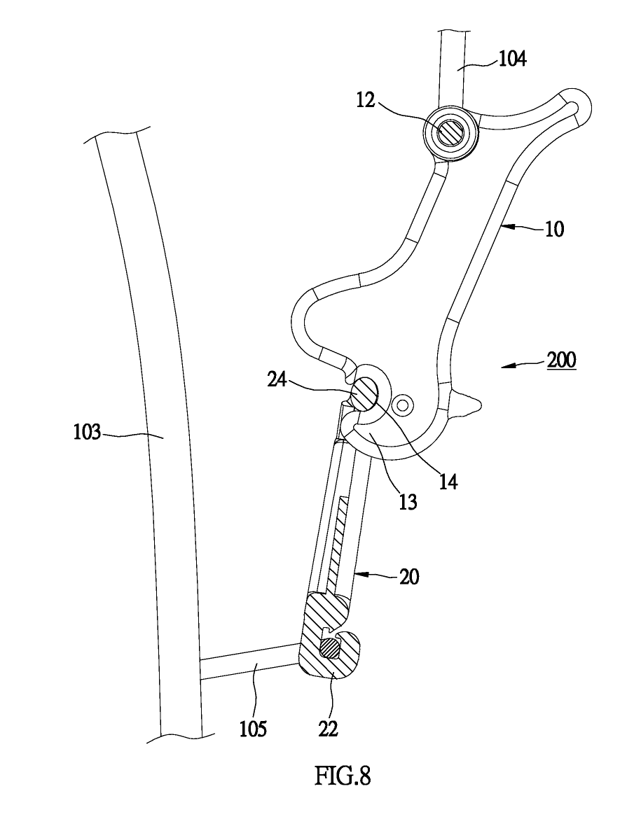

As shown in FIG. 6, the blocking member 20 has a connecting portion, which is a hook 22, to connect a coupler of the valance 103. In the present embodiment, the coupler is an eye screw 105, as shown in FIG. 8. The blocking member may be without the connecting portion (not shown), and the valance 103 is directly fastened to the blocking member 20. The blocking member 20 further has a blocking portion 24, which is a curved bar with an oval cross section B, as shown in FIG. 7. The oval cross section B of the blocking portion 24 has a long axis 24a and a short axis 24b orthogonal to the long axis 24a. A length of the long axis 24a of the blocking portion 24 is greater than the maximum width W of the gateway 16 of the engaging space 14, and a length of the short axis 24b is short than the maximum width W of the gateway 16 of the engaging space 14.

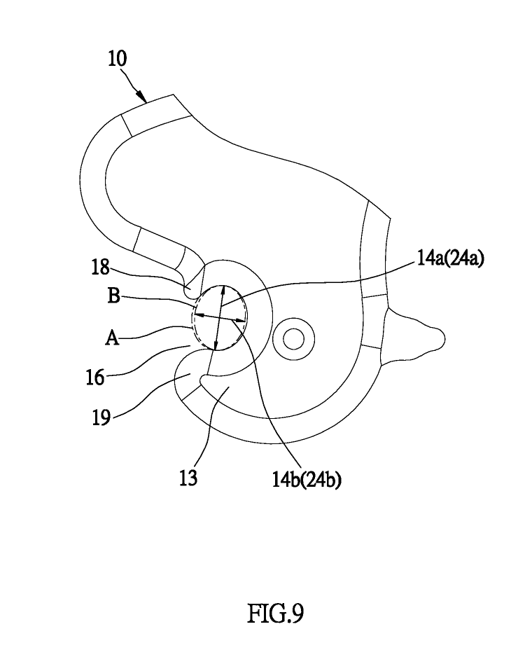

FIG. 8 and FIG. 9 show that the hanging member 10 is engaged with the blocking member 20. In this condition, the long axis 24a of the blocking portion 24 overlaps the long axis 14a of the engaging space 14, and the hanging member 10 is a rigid body that the blocking portion 24 of the blocking member 20 is hooked by the hooking portion 13 of the hanging member 10. For a normal operation of the cord 104 to fold and unfold the valance 103 or mount the window covering 100, the hanging member 10 and the blocking member 20 of the safety cord releaser 200 will not disengage even while the cord 104 is pulled with a great strength.

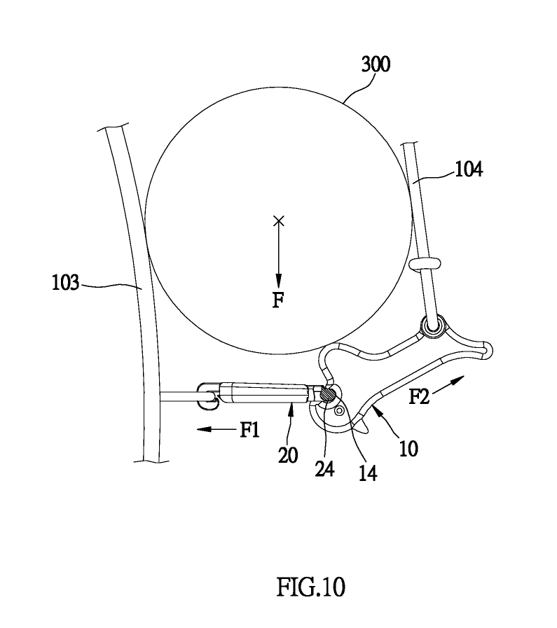

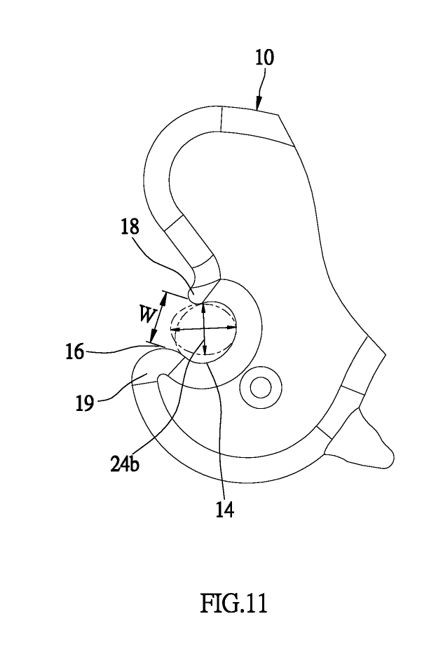

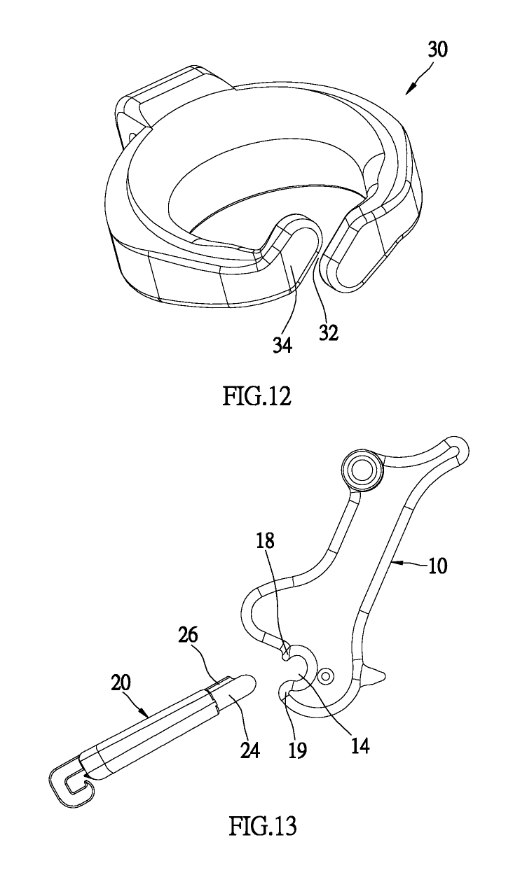

FIG. 10 shows a neck 300 between the cord 104 and the valance 103 and a child tries to move downward. A force F of the child moving downward enlarges a distance between the cord 104 and the valance 103 and further moves the hanging member 10 and the blocking member 20 to a horizontal position from a vertical position as shown in FIG. 11 that the short axis 24b of the blocking portion 24 is substantially parallel to the maximum width W of the gateway 16. With component forces F1 and F2 produced by the force F, the blocking portion 24 of the blocking member 20 will slide out of the engaging space 14 via the gateway 16 to disengage the hanging member 10 from the blocking member 20.

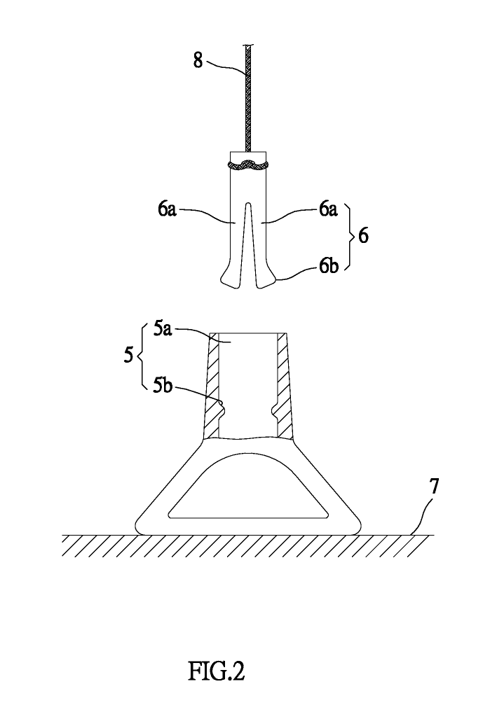

In order to avoid the strangulation accident, the window covering 100 of the present invention is further provided with a plurality of couplers 30 fastened on the valance 103, as shown in FIG. 2. The coupler 30 is a C-ring having an opening 32 and a curved section 34 extended to the opening 32 that the cord 104 may slide along the curved section 34 to leave the coupler 30 via the opening 32. The cord 104 passes through all the couplers 30 as shown in FIG. 3. The curved section 34 of the coupler 30 has a round end to avoid damaging the cord 104.

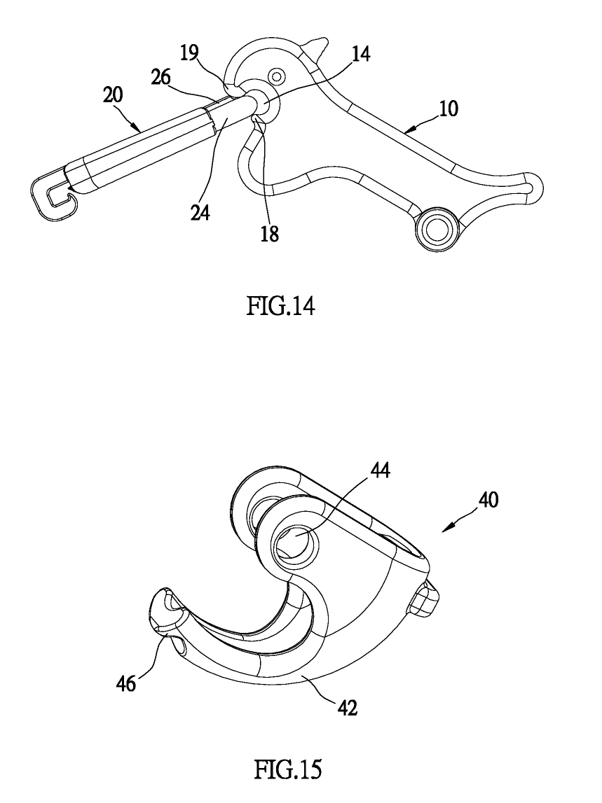

The present invention further provides a foolproof structure to avoid false installation of the cord releaser 200. The blocking member 20 is provided with a protrusion 26 on an inner side of the blocking portion 24. FIG. 13 shows the hanging member 10 at a correct position, the protrusion 26 at top, that the hanging member 10 is able to engage the blocking member 20. On the contrary, FIG. 14 shows the hanging member 10 at an incorrect position, the protrusion 26 at bottom, that a second edge 19 will be stopped by the protrusion 26 when one tries to engage the engaging space 14 of the hanging member 10 with the blocking portion 24 of the blocking member 20. It causes the hanging member 10 unable to engage the blocking member 20.

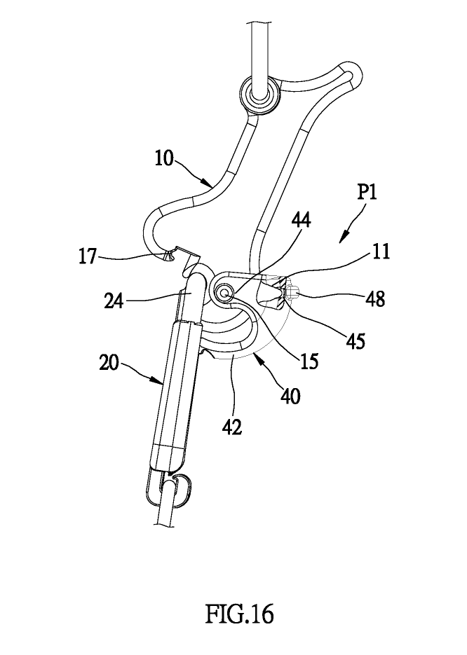

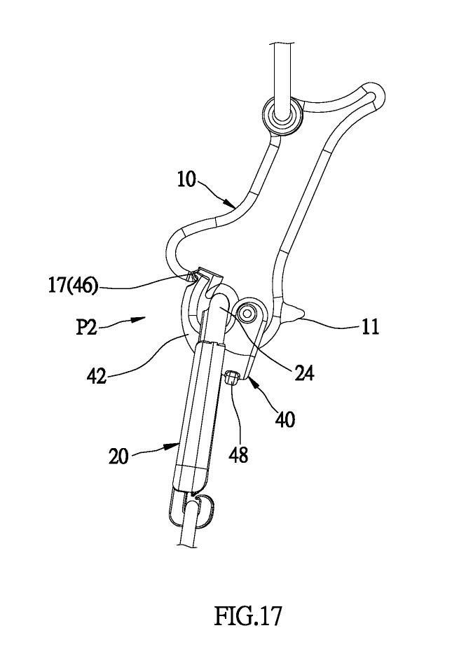

Without the consideration of children's safety, the cord releaser 200 of the present invention may be provided with a cover 40 to enhance the connection of the hanging member 10 and the blocking member 20. As shown in FIG. 15, the cover 40 has a curved body 42 with a bore 44 and a protrusion 46 at opposite sides. The hanging member 10 is provided with a post 15 and a hook 17 at opposite sides of the engaging space 14. The bore 44 of the cover 40 is engaged with the post 15 of the hanging member 10 that the cover 40 is pivoted on the hanging member 10 to be moved between an uncovered position P1 (FIG. 16) and a covered position P2 (FIG. 17). At the uncovered position P1, the gateway 16 of the engaging space 14 is exposed that the blocking portion 24 is free to access the engaging space 14 via the gateway 16, and the cover 40 has a recess 45 at an inner side engaged with a protrusion 11 on the hanging member 10 to secure the cover 40 at the uncovered position P1. At the covered position P2, the body 42 of the cover 40 blocks the gateway 16 of the engaging space 14 that the blocking portion 24 has no chance to leave the engaging space 14 when the hanging member 10 is engaged with the blocking member 20, and the protrusion 46 of the cover 40 is engaged with the hook 17 of the hanging member 10 to secure the cover 40 at the covered position P2. The cover 40 may prevent the hanging member 10 and the blocking member 20 from unexpectedly disengagement. The cover 40 further has a block 48 for users' manipulation.

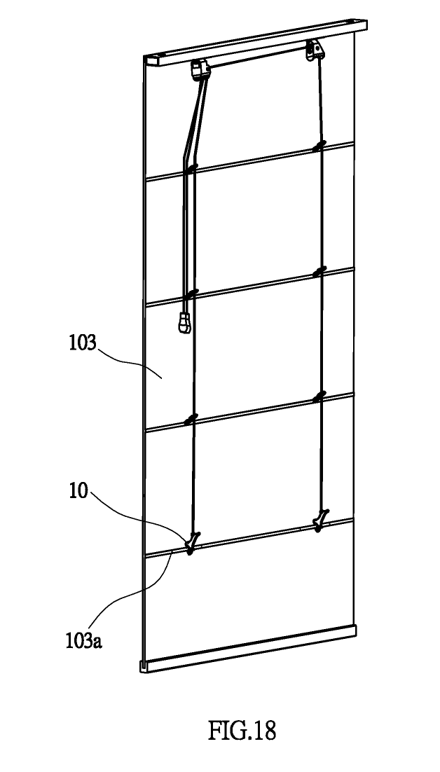

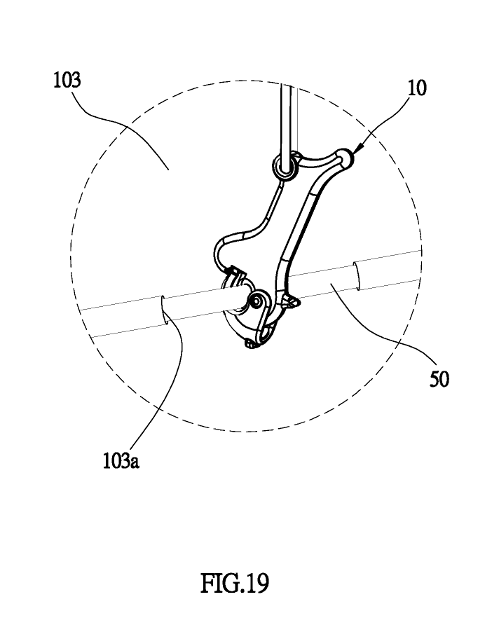

In addition to the blocking member 200 as described above, FIG. 18 and FIG. 19 show an alternate blocking member having a bar 50 fixed to the valance 103. The valance 103 is stitched with three cloth tubes, and the bar 50 is fitted into holes 103a of the cloth tubes. The bar 50 is exposed at spaces between the cloth tubes to be engaged with the hanging member 10. The bar 50 has an oval cross section the same as the blocking portion 24 of the blocking member 20 so it functions the same as above. The description above is a few preferred embodiments of the present invention and the equivalence of the present invention is still in the scope of claim construction of the present invention.

What is claimed is:

1. A cord releaser, comprising:
a hanging member having an engaging portion, which has an engaging space, a gateway to be an entrance of the engaging space, and two edges at opposite sides of the gateway, wherein a distance between the edges is a maximum width of the gateway; and
a blocking member having a blocking portion to be detachably engaged with the engaging space of the hanging portion which has a long axis and a short axis at a cross section thereof, wherein the long axis is greater than the maximum width of the gateway of the hanging member, and the short axis is shorter than the maximum width of the gateway;
wherein in a condition of the long axis of the blocking portion of the blocking member substantially pointing to the gateway of the hanging member, the blocking member is able to be disengaged with the hanging member.

2. The cord releaser as defined in claim 1, wherein the cross section of the blocking portion of the blocking member is oval and the long axis and the short axis are orthogonal, and the engaging space of the hanging member, which is complementary to the blocking portion of the blocking member, having a long axis and a short axis that the blocking member is unable to be disengaged with the hanging member when the blocking portion is engaged with the engaging space and the long axis of the blocking portion is substantially parallel to the maximum width of the gateway.

3. The cord releaser as defined in claim 1, further comprising a cover pivoted on the hanging member to be moved between a covered position, in which a body of the cover blocks the gateway of the hanging member, and an uncovered position, in which the body of the cover exposes the gateway of the hanging member.

4. The cord releaser as defined in claim 3, wherein the hanging member is provided with a post and a hook at opposite sides of the engaging space, and the cover is provided with a bore engaged with the post of the hanging member to pivot the cover on the hanging member and a protrusion to be engaged with the hook when the cover is moved to the covered position.

5. The cord releaser as defined in claim 1, wherein the blocking portion of the blocking member is provided with a protrusion to be in touch with the edge when the hanging member tries to be engaged with the blocking member in an incorrect position.

6. A window covering, comprising:
a top rail, a bottom rail, a valance connected to the top rail and the bottom rail, and a cord for pulling to fold and unfold the valance;
a hanging member including a pivoting portion to be connected to an end of the cord and a engaging portion opposite to the pivoting portion having an engaging portion, which has an engaging space, a gateway to be an entrance of the engaging space, and two edges at opposite sides of the gateway, wherein a distance between the edges is a maximum width of the gateway; and
a blocking member, which is provided on the valance adjacent to the bottom rail, having a blocking portion to be detachably engaged with the engaging space of the hanging portion which has a long axis and a short axis at a cross section thereof, wherein the long axis is greater than the maximum width of the gateway of the hanging member, and the short axis is shorter than the maximum width of the gateway;
wherein in a condition of the short axis of the blocking portion of the blocking member substantially pointing to the gateway, the blocking member is able to be disengaged with the hanging member.

7. The window covering as defined in claim 6, wherein the cross section of the blocking portion of the blocking member is oval and the long axis and the short axis are orthogonal, and the engaging space of the hanging member, which is complementary to the blocking portion of the blocking member, having a long axis and a short axis that the blocking member is unable to be disengaged with the hanging member when the blocking portion is engaged with the engaging space and the long axis of the blocking portion is substantially parallel to the maximum width of the gateway.

8. The window covering as defined in claim 6, further comprising a cover pivoted on the hanging member to be moved between a covered position, in which a body of the cover blocks the gateway of the hanging member, and an uncovered position, in which the body of the cover exposes the gateway of the hanging member.

9. The window covering as defined in claim 8, wherein the hanging member is provided with a post and a hook at opposite sides of the engaging space, and the cover is provided with a bore engaged with the post of the hanging member to pivot the cover on the hanging member and a protrusion to be engaged with the hook when the cover is moved to the covered position.

10. The window covering as defined in claim 6, wherein the blocking portion of the blocking member is provided with a protrusion to be in touch with the edge when the hanging member tries to be engaged with the blocking member in an incorrect position.

11. The window covering as defined in claim 6, further comprising a plurality of couplers provided on the valance for the cord passing therethrough, wherein each of the coupler has an opening and a curved section extended to the opening that the cord may slide along the curved section to leave the coupler via the opening.
